(19) United States
(12) Patent Application Publication
(10) Pub. No.: US 2014/0126138 A1
(43) Pub. Date: May 8, 2014

(54) SERIAL ADVANCED TECHNOLOGY ATTACHMENT DUAL IN-LINE MEMORY MODULE DEVICE AND MOTHERBOARD FOR SUPPORTING THE SAME

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: WAN-HONG ZHANG, Shenzhen (CN); LI-ZHEN HU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/686,984

(22) Filed: Nov. 28, 2012

(30) Foreign Application Priority Data
Nov. 8, 2012 (CN) 2012104434068

(51) Int. Cl. G06F 1/18

(52) U.S. Cl. CPC G06F 1/185
USPC 361/679.32; 361/679.31

(57) ABSTRACT

A serial advanced technology attachment dual in-line memory module (SATA DIMM) device includes a number of storage chips, a control chip, a power circuit, and a SATA connector. The control chip is connected to the storage chips. The power circuit is connected to the control chip and the storage chips for providing a voltage to the control chip and the storage chips. The SATA connector includes an idle pin, a pair of signal input pins, a pair of signal output pins, and a pair of ground pins. The idle pin is connected to the power circuit. The signal input pins and the signal output pins are connected to the control chip. The ground pins are grounded.

### BACKGROUND

1. Technical Field

The present disclosure relates to a serial advanced technology attachment dual in-line memory module (SATA DIMM) device and a motherboard for supporting the SATA DIMM device.

2. Description of Related Art

Solid state drive (SSD) devices store data on chips instead of on magnetic or optical discs. One type of SSD has the form factor of a DIMM module and is called a SATA DIMM device. The SATA DIMM device can be inserted into a memory slot of a motherboard through an edge connector arranged on the SATA DIMM device, to receive voltages from the motherboard through the memory slot and receive SATA signals through SATA connectors arranged on the SATA DIMM device and connected to a SATA connector of the motherboard. The DOM device receives voltages through a power interface from the motherboard and receives SATA signals through a SATA connector from the motherboard. However, the edge connectors on SATA DIMM devices and the power interfaces on DOM devices occupy a lot of space.

### BRIEF DESCRIPTION OF THE DRAWINGS

Many aspects of the embodiments can be better understood with reference to the following drawings. The components in the drawing are not necessarily drawn to scale, the emphasis instead being placed upon clearly illustrating the principles of the present embodiments.

FIG. 1 is a block diagram of a serial advanced technology attachment dual in-line memory module (SATA DIMM) device in accordance with an exemplary embodiment of the present disclosure.

FIG. 2 is a circuit diagram of a motherboard for supporting the SATA DIMM device of FIG. 1 in accordance with an exemplary embodiment of the present disclosure.

### DETAILED DESCRIPTION

The disclosure, including the drawing, is illustrated by way of example and not by way of limitation. References to “an” or “one” embodiment in this disclosure are not necessarily to the same embodiment, and such references mean at least one.

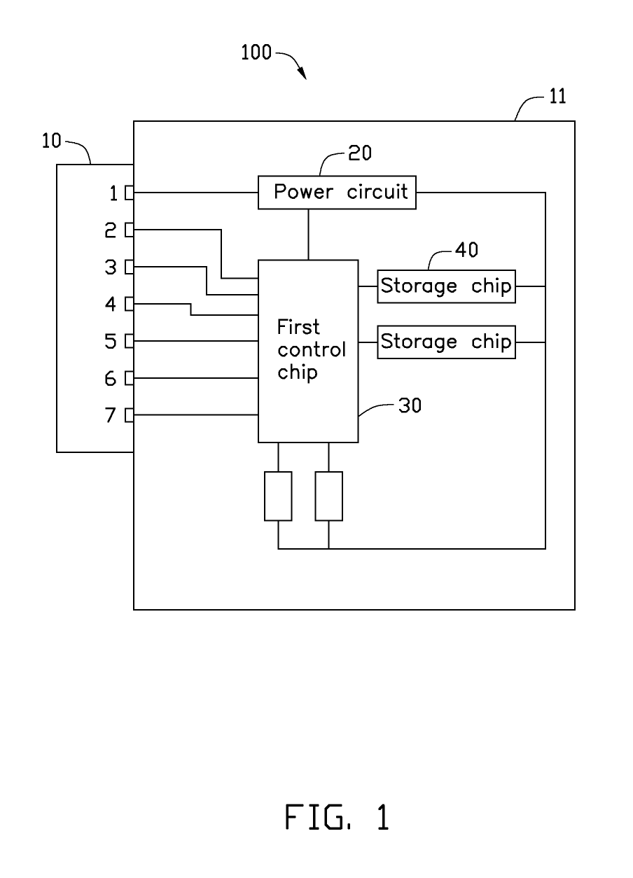

Referring to FIG. 1, a serial advanced technology attachment dual in-line memory module (SATA DIMM) device 100 in accordance with an exemplary embodiment includes a substantially rectangular circuit board 11. A serial advanced technology attachment (SATA) connector 10, a power circuit 20, a first control chip 30, and a plurality of storage chips 40 are arranged on the circuit board 11. The SATA connector 10 is arranged on any side of the circuit board 11. The SATA connector 10 includes an idle pin 1, a pair of signal input pins 2 and 3, a pair of signal output pins 5 and 6, and a pair of ground pins 4 and 7. The idle pin 1 is connected to the power circuit 20. The signal input pins 3 and 4 and the signal output pins 5 and 6 are connected to the first control chip 30. The power circuit 20 is connected to the first control chip 30 and the storage chips 40, to provide voltages to the first control chip 30 and the storage chips 40. The ground pins 4 and 7 are connected to the first control chip 30 and a ground layer (not shown) of the circuit board 11.

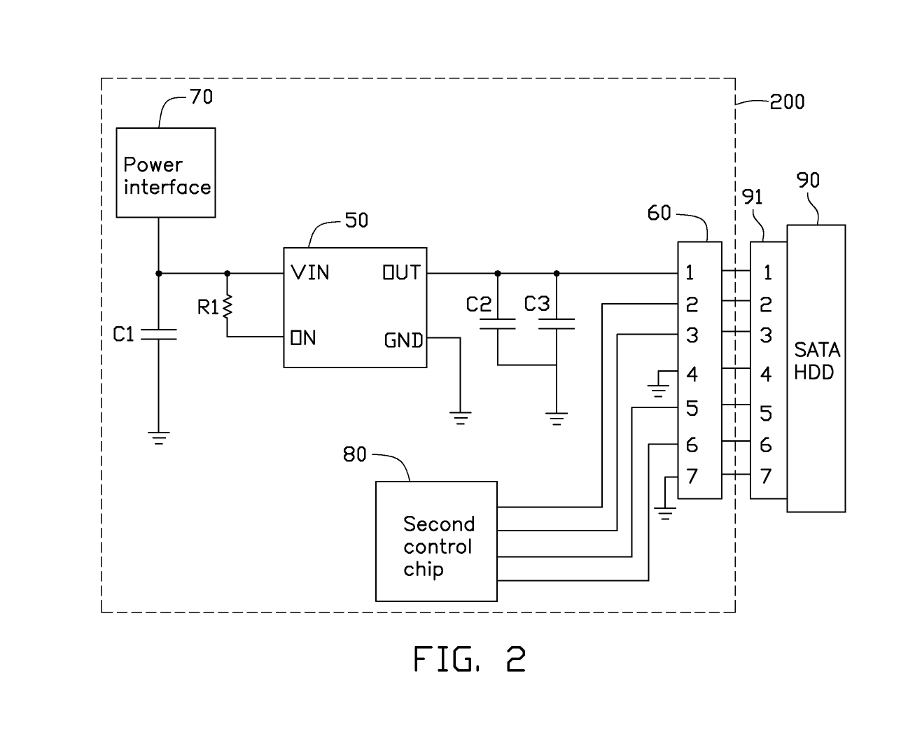

Referring to FIG. 2, an embodiment of a motherboard 200 includes a power interface 70, a power control chip 50, a SATA connector 60, a second control chip 80, a resistor R1, and capacitors C1 -C3. Other elements of the motherboard 200 are known in the art and are omitted from this description. The SATA connector 60 includes an idle pin 1, a pair of signal input pins 2 and 3, a pair of signal output pins 5 and 6, and a pair of ground pins 4 and 7. The power interface 70 is connected to a voltage input pin VIN of the power control chip 50 and also grounded through the capacitor Cl. The resistor R1 is connected between the voltage input pin VIN of the power control chip 50 and an enable pin ON of the power control chip 50. An output pin OUT of the power control chip 50 is connected to the idle pin 1 of the SATA connector 60. The capacitors C2 and C3 are connected in parallel between the output pin OUT of the power control chip 50 and ground. The signal input pins 2 and 3 and the signal output pins 5 and 6 of the SATA connector 60 are connected to the second control chip 80. The ground pins 4 and 7 of the SATA connector 60 are connected to a ground layer (not shown) of the motherboard 200.

In use, when the SATA DIMM device 100 is electrically connected to the motherboard 200 through the SATA connector 10 connected to the SATA connector 60, and the motherboard 200 is powered on, the power control chip 50 receives a high level signal through the enable pin ON of the power control chip 50. The power control chip 50 receives a voltage from the power interface 70 through the voltage pin VIN and outputs the voltage to the power circuit 20 of the SATA DIMM device 100 through the output pin OUT of the power control chip 50, the idle pin 1 of the SATA connector 60, and the idle pin 1 of the SATA connector 10. The power circuit 20 converts the voltage and outputs the converted voltage to the first control chip 30 and the storage chips 40. The first control chip 30 of the SATA DIMM device 100 transmits voltages and data to the second control chip 80 of the motherboard 200 through the signal input pins 2 and 3 and the signal output pins 5 and 6 of the SATA connectors 10 and 60. When a SATA hard disk drive (HDD) 90 is electrically connected to the motherboard 200 through the SATA connector 60 being connected to a SATA connector 91 of the SATA HDD 90, and the motherboard 200 is powered on, due to an idle pin 1 of the SATA connector 91 being connected to a ground layer of the SATA HDD 90, thus, when the SATA HDD 90 is electrically connected to the motherboard 200 through the SATA connector 60 being connecting to the SATA connector 90, the idle pin 1 of the SATA connector 90 is electrically connected to the idle pin 1 of the SATA connector 60. Namely, the idle pin 1 of the SATA connector 60 is also grounded. Thus, the output pin OUT of the power control chip 50 is grounded, and the power control chip 50 does not operate. A voltage from the power interface 70 cannot be provided to the SATA HDD 90. The second control chip 80 of the motherboard 200 transmits data to the SATA HDD 90 through the signal input pins 2 and 3 and signal output pins 5 and 6 of the SATA connectors 60 and 91.

When the motherboard 200 is connected to the SATA DIMM device 100, the power control chip 50 operates, and the motherboard 200 transmits voltages and data to the SATA DIMM device 100 through the SATA connectors 10 and 60. When the motherboard 200 is connected to the SATA HDD 90, the power control chip 50 does not operate, and the motherboard 200 transmits data to the SATA HDD 90 through the SATA connectors 60 and 91. Therefore, the motherboard 200 can communicate with the SATA DIMM device 100, and also can communicate with the SATA HDD 90.

Even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A serial advanced technology attachment dual in-line memory module (SATA DIMM) device, comprising:
a circuit board;
a plurality of storage chips arranged on the circuit board;
a control chip arranged on the circuit board and connected to the plurality of storage chips;
a power circuit arranged on the circuit board and connected to the control chip and the plurality of storage chips, to provide a voltage to the control chip and the plurality of storage chips; and
a SATA connector arranged on the circuit board, the SATA connector comprising:
an idle pin connected to the power circuit;
a pair of signal input pins connected to the control chip;
a pair of signal output pins connected to the control chip; and
a pair of ground pins connected to the control chip and grounded.

2. The SATA DIMM device of claim 1, wherein the SATA connector is arranged on any side of the circuit board.

3. A motherboard for supporting a serial advanced technology attachment dual-in-line memory module (SATA DIMM) device, the motherboard comprising:
a circuit board;
a power interface arranged on the circuit board;
a control chip arranged on the circuit board;
a power control chip arranged on the circuit board, the power control chip comprising:
a voltage input pin connected to the power interface; and
an output pin; and
a SATA connector arranged on the circuit board, the SATA connector comprising:
an idle pin connected to the output pin of the power control chip;
a pair of signal input pins connected to the control chip;
a pair of signal output pins connected to the control chip; and
a pair of ground pins grounded;
wherein when the motherboard is connected to the SATA DIMM device through the SATA connector, the power control chip operates, the motherboard transmits voltages and data to the SATA DIMM device through the SATA connector, when the motherboard is connected to a SATA hard disk drive (HDD) through the SATA connector, the power control chip does not operate, the motherboard transmits data to the SATA HDD through the SATA connector.

4. The motherboard of claim 3, further comprising a resistor, and first to third capacitors, wherein the resistor is connected between the voltage input pin of the power control chip and an enable pin of the power control chip, the first capacitor is connected between the voltage input pin of the power control chip and ground, the second and third capacitors are connected in parallel between the output pin of the power control chip and ground.

5. A motherboard assembly, comprising:
a serial advanced technology attachment dual-in-line memory module (SATA DIMM) device comprising:
a first circuit board;
a plurality of storage chips arranged on the first circuit board;
a first control chip arranged on the first circuit board and connected to the plurality of storage chips;
a power circuit arranged on the first circuit board and connected to the first control chip and the plurality of storage chips, to provide a voltage to the first control chip and the plurality of storage chips; and
a first SATA connector arranged on the first circuit board, the first SATA connector comprising:
an idle pin connected to the power circuit;
a pair of signal input pins connected to the first control chip;
a pair of signal output pins connected to the first control chip; and
a pair of ground pins connected to the first control chip and grounded; and
a motherboard comprising:
a second circuit board;
a power interface arranged on the second circuit board;
a second control chip arranged on the second circuit board;
a power control chip arranged on the second circuit board, the power control chip comprising:
a voltage input pin connected to the power interface; and
an output pin; and
a second SATA connector arranged on the second circuit board, the second SATA connector comprising:
an idle pin connected to the output pin of the power control chip;
a pair of signal input pins connected to the second control chip;
a pair of signal output pins connected to the second control chip; and
a pair of ground pins grounded;
wherein when the motherboard is connected to the SATA DIMM device through the first SATA connector connected to the second SATA connector, the power control chip operates, the motherboard transmits voltages and data to the SATA DIMM device through the first and second SATA connectors, when the motherboard is connected to a SATA hard disk drive (HDD) through the second SATA connector, the power control chip does not operate, the motherboard transmits data to the SATA HDD through the second SATA connector.

6. The motherboard assembly of claim 5, wherein the first SATA connector is arranged on any side of the first circuit board.

7. The motherboard assembly of claim 5, wherein the motherboard further comprises a resistor, and first to third capacitors, wherein the resistor is connected between the voltage input pin and an enable pin of the power control chip, the first capacitor is connected between the voltage input pin of the power control chip and ground, the second and third capacitors are connected in parallel between the output pin of the power control chip and ground.
